(19) United States
(12) Patent Application Publication
(10) Pub. No.: US 2023/0008974 A1
(43) Pub. Date: Jan. 12, 2023

(54) METHODS, SYSTEMS, AND COMPUTER PROGRAM PRODUCTS CONFIGURED TO PROVIDE CONSISTENT LOOK AND FEEL FOR USER INPUT

(71) Applicant: Toshiba Global Commerce Solutions Holdings Corporation, Tokyo (JP)

(72) Inventors: Bradley Thomas Marchesseault, Cary, NC (US); Paul D. Lindsey, Springdale, AR (US)

(21) Appl. No.: 17/651,159

(22) Filed: Feb. 15, 2022

Related U.S. Application Data
(60) Provisional application No. 63/219,586, filed on Jul. 8, 2021.

(51) Int. Cl. G06F 3/0481; G06Q 20/20

(52) U.S. Cl. CPC G06F 3/0481; G06Q 20/20; G06F 2203/04803

(57) ABSTRACT

A method of operating a Point-of-Sale terminal can include operating a root web application in a Uniform Resource Locator browser on the Point-of-Sale terminal, wherein the root web application is configured to provide respective communication channels between a plurality of web applications each running in a respective iFrame within the root web application, receiving, at a user intervention web application configured to render a user input box with a first graphical arrangement of elements in an iFrame on a display of the POS terminal, requests for user input from the plurality of web applications, and rendering, using the user intervention web application, a user input box for each of the requests for the user input from the plurality of web applications, wherein each user input box rendered with the first graphical arrangement of elements.

### CROSS-REFERENCE TO RELATED APPLICATION AND CLAIM FOR PRIORITY

This application claims priority to U.S. Provisional Patent Application Ser. No. 63/219,586, titled METHODS AND SYSTEMS FOR CROSS IFRAME USER INTERVENTION, filed on Jul. 8, 2021 in the United States Patent and Trademark Office, the entirety of which is incorporated herein by reference.

### BACKGROUND

Some conventional point of sale terminal systems require each web application in the system that requests user input to have dedicated instructions that render the prompts for such user input onto the display. Further, some conventional point of sale terminal systems operate such that only the application that is currently being used to generate a dialog box that is displayed. Accordingly, only one iFrame application may cause a pop-up dialog box to appear to the user. Therefore, callback features, including data sharing among stand-alone IFrames, are not enabled.

### BRIEF DESCRIPTION OF THE DRAWINGS

FIG. 1 is a block diagram of web applications configured to operate in iFrames within a root web application to provide consistent look and feel for user input via a user intervention web application in accordance with some embodiments of the present disclosure.

FIG. 2 is a user interface of a point of sale terminal environment generated using web applications operating within respective iFrames including a user intervention web application in accordance with some embodiments of the present disclosure.

FIGS. 3 and 4 are schematic representations of alternative user input boxes rendered to have a first look and feel and a second look and feel, respectively, by a user intervention web application in accordance with some embodiments of the present disclosure.

FIGS. 5 and 6 are schematic representations of operations of different web applications within a point of sale terminal environment providing consistent look and feel for user input boxes via a user intervention web application in accordance with some embodiments of the present disclosure.

FIG. 7 is a flowchart illustrating methods of providing consistent look and feel for user input using a user intervention web application in accordance with some embodiments of the present disclosure.

FIG. 8 is a block diagram of a point of sale terminal system including a user intervention web application in some embodiments according to the present disclosure.

### DETAILED DESCRIPTION OF EMBODIMENTS ACCORDING TO THE PRESENT DISCLOSURE

Embodiments according to the present disclosure can provide methods, systems, and computer program products configured to provide consistent look and feel for user input. Pursuant to these embodiments, a method of operating a Point-of-Sale terminal can include operating a root web application in a Uniform Resource Locator browser on the Point-of-Sale terminal, wherein the root web application is configured to provide respective communication channels between a plurality of web applications each running in a respective iFrame within the root web application, receiving, at a user intervention web application configured to render a user input box with a first graphical arrangement of elements in an iFrame on a display of the POS terminal, requests for user input from the plurality of web applications, and rendering, using the user intervention web application, a user input box for each of the requests for the user input from the plurality of web applications, wherein each user input box rendered with the first graphical arrangement of elements.

The present disclosure now will be described more fully hereinafter with reference to the accompanying drawings, in which illustrative embodiments of the present disclosure are shown. This present disclosure may, however, be embodied in many different forms and should not be construed as limited to the embodiments set forth herein; rather, these embodiments are provided so that this disclosure will be thorough and complete, and will fully convey the scope of the present disclosure to those skilled in the art. Like numbers refer to like elements throughout.

As appreciated by the present inventors, current web applications do not share prompting, requiring each web application to provide its own mechanism for prompting for user input. As a result, those prompts may not be visible if another iFrames is “in focus.” Still further separately maintained, developed web applications may not provide a consistent look and feel prompting for user input.

According to some aspects of the present disclosure, two or more web applications can be loaded simultaneously into a root web application that uses iFrames for the two or more web applications. In some embodiments, the root web application can also include a user intervention web application (sometimes referred to herein as a “Callback service”) that is used by each of the web applications when prompting for user input. The user intervention web application can include instructions for the rendering a user input box to receive the user input requested by any of the web applications.

For example, in some embodiments according to the present disclosure, web applications A and B, and a user intervention web application C, may each operate simultaneously within a primary root web application. The root web application along with the web applications A, B, and the user intervention web application C can provide a portion of operations of a point-of-sale terminal system that enables an operator to complete the purchase of items in a retail environment. It will be understood that the web applications described herein can each have an associated iFrame used by the web application to display information for the point-of-sale terminal. For example, as described herein, the web applications A, B, and C can each have an associated iFrame. Accordingly, the terms web application and iFrame are sometimes used herein interchangeably.

The root web application (i.e., root) is responsible for loading the web applications A, B, and C into individual iFrames and providing secure communications between each. In some embodiments according to the present disclosure, the web applications A and B can be configured as stand-alone web applications that can serve unrelated or related purposes. The user intervention web application C is configured to provide a user intervention callback service that may normally be hidden from the user until needed.

When web application A is visible or hidden from view, it can request input from the current user by issuing a request through a communication channel in the root to user intervention web application C. The user intervention web application C then issues a request to root to allow a dialog box (sometimes referred to herein as a “user input box”) rendered by the user intervention web application C visible as an overlay over the currently visible web application(s) and assume focus so that the user can provide the requested input to the input box. The user intervention web application C renders the input box using a graphical arrangement of the elements that is configured by instructions included in the user intervention web application C in the associated iFrame.

Furthermore, web application B can also (and potentially concurrently with web application A) request input from the current user by issuing a separate request through a communication channel in the root between web application B and user intervention web application C. The user intervention web application C issues a request to root to allow the user intervention web application C to render another user input box visible as an overlay over the currently visible web application(s) and assume focus so that the user can provide the requested input to the input box. It will be understood, however, that the user intervention web application C renders the second input box using the same graphical arrangement of the elements used for the first input box using the instructions included in the user intervention web application C. It will be further understood that, that the web application B may request different information from the user than what was requested by the web application A. However, despite the difference in the input requested, the user intervention web application C can render both input boxed to have the same look and feel so that the user has a more consistent experience.

The look and feel of the input box can may be expressed in any form, including, for example, in standard markup languages including, but not limited to HTML, CSS, or Javascript. The look and feel data can be any series of elements that create the content structure of a web page or application. For example, look and feel data may include the layout, format, color schemes, font, or any other data identifying the visual aspects of the user interface.

In some embodiments according to the present disclosure, an Application Programming Interface (API) can be used by a web application to transmit the request for user input. In some embodiments, an API call for requested input from the user can include the information that is to be rendered by the user intervention web application C in iFrame C. For example, the API call can specify a title, prompt, description, input fields, buttons, to be rendered by the user intervention web application C in the iFrame. In some embodiments according to the present disclosure, the information to be rendered can be displayed according to a graphical arrangement of elements or information to appear in the user input box. In some embodiments, the API can also allow the look and feel to be specified as part of the call. Accordingly, the API call may specify which look and feel is to be used by the user intervention web application C to display the information in the associated iFrame.

When the user completes entering the data or cancels the intervention represented by the user input box, the user intervention web application C transmits the user data and status of the intervention (submitted or canceled) back to originating web application A or B through the respective communication channel. The user intervention web application C also issues a request to root to be hidden from view and return focus to the web application that issues the request for user input.

In the case that requests for user data are issued by multiple web applications at the same time or overlapping in time, each web application assigns a priority to the request that is transmitted to the user intervention web application C. The priorities are used to determine which request is to be handled first, with lower priority requests being queued until no higher priority requests are pending. The user intervention web application C stores the list of outstanding requests internally along with requesting web application information and displays each request in order of priority until all requests have been handled.

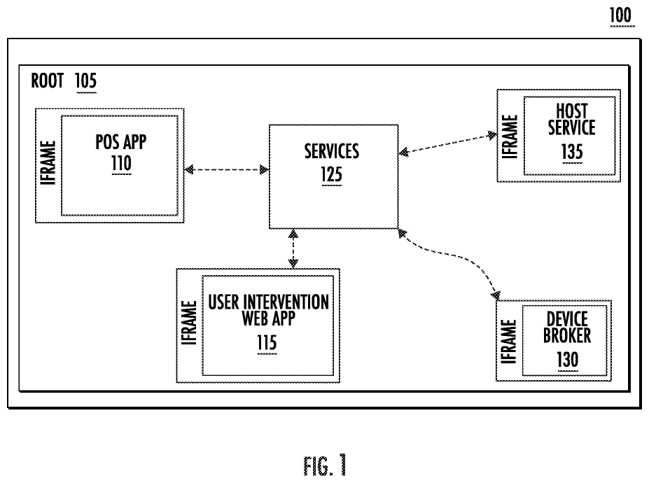

FIG. 1 is a block diagram of a point-of-sale terminal system 100 including a plurality of web applications configured to operate in corresponding iFrames within a root web application 105 to provide a more consistent look and feel for user input via a user intervention web application 115 (i.e., callback service) in accordance with some embodiments of the present disclosure. According to FIG. 1, each web application that operates within the point-of-sale terminal system 100 can have an associated iFrame that can be used to display information to a user of the system 100. A services application 125 may serve as a two-way communication channel between the web applications. The services application 125 may also be used to prioritize requests made to the user intervention web application 115 in order of time, need, or importance.

As further shown in FIG. 1, in some embodiments according to the present disclosure, the system 100 can include a point-of-sale application 110 that operates to complete a sales transaction using data such as an SKU of a product. The system 100 can also include a device broker web application 130 that can provide backend support for the system 100, such as error handling or feedback for one of the web applications, system software and/or hardware, such as a printer. During operations, for example, the printer may signal the system 100 that the printer's paper supply is empty wherein the device broker web application 130 may generate an input box to alert the user. The system 100 can also include a host service web application 135 that is configured to provide information required by the POS web application 110 to complete the sales transaction, such as a price of a product. The system 100 can also include other web applications/iFrames.

It will be understood that each of the web applications can be configured to request input from the user. The user can be prompted for the information required by any of the web applications by the user intervention web application 115. The user intervention web application 115 include instructions that are configured to render a user input box to prompt the user for the information requested by the web applications. Moreover, in some embodiments according to the present disclosure, the user intervention web application 115 is configured to render each of the user input boxes to have the same look and feel regardless of which one of the web applications requested the input from the user.

During operations of the system 100, the web applications 110, 135, and 130 can request information from the user by transmitting a respective request to the user intervention web application 115 via a secure communications channel provided by the root 105. The root 105 is also responsible for making the user intervention web application 115 visible (or hidden) so that the user intervention web application 115 can render the user input box as an overlay over the other web applications shown on the display of the system 100.

In operations, a user input box can appear in the foreground of a user interface of the system 100 as a pop-up when any of the web applications requests user input data. For example, during a transaction, the POS web application 110 may require information, such as a UPC or SKU of an item being purchased, to complete the transaction. Accordingly, the POS web application 110 may send a request to the UPC number or SKU associated with the item to the user intervention web application 115. The user intervention web application 115 can then render a user input box so that the user can provide the requested SKU or UPC. Once the SKU or UPC is returned, the user intervention web application 115 can again be hidden and the POS web application 110 may complete the sales transaction.

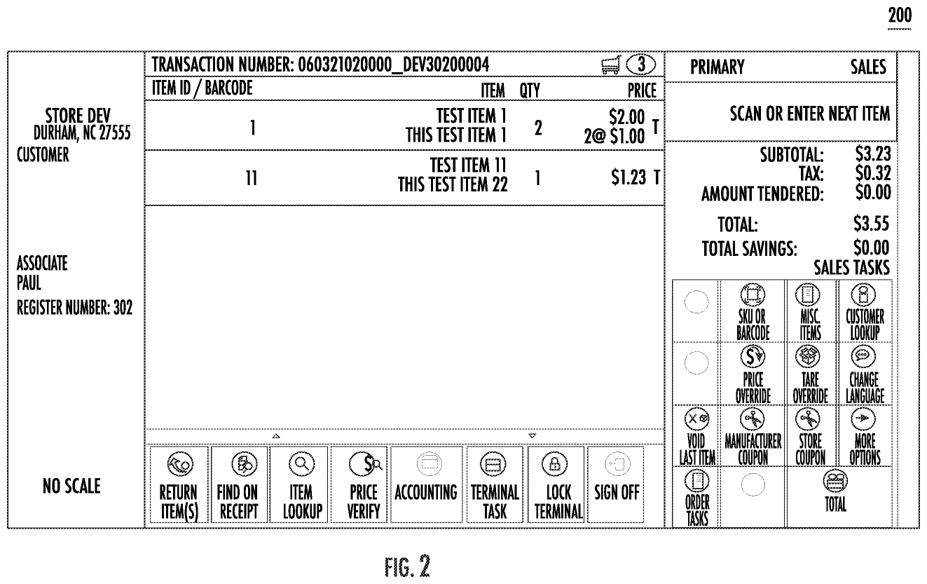

FIG. 2 is a schematic illustration of a user interface 200 of the point-of-sale terminal 100 rendered by the POS web application 110 operating within a respective iFrame in some embodiments of the present disclosure. According to FIG. 2, the other web application shown in FIG. 1 can request input from the user via requests transmitted to the user intervention web application 115. The user intervention web application 115 render the user input boxes to appear as overlays onto the user interface 200.

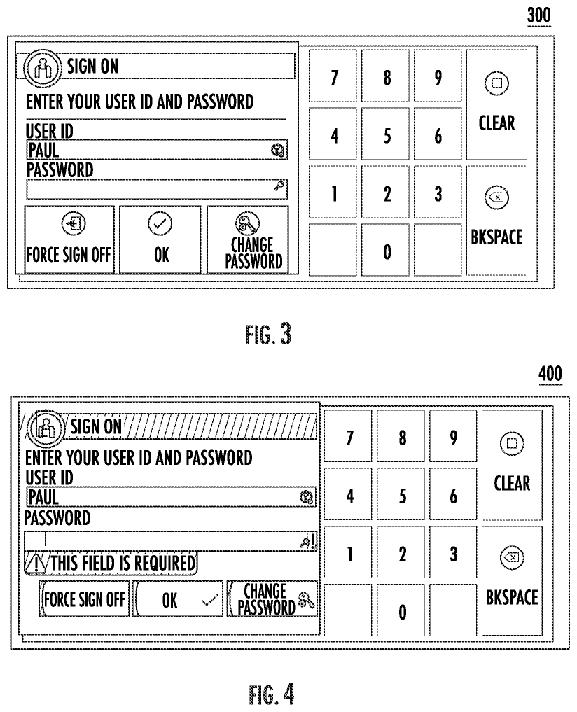

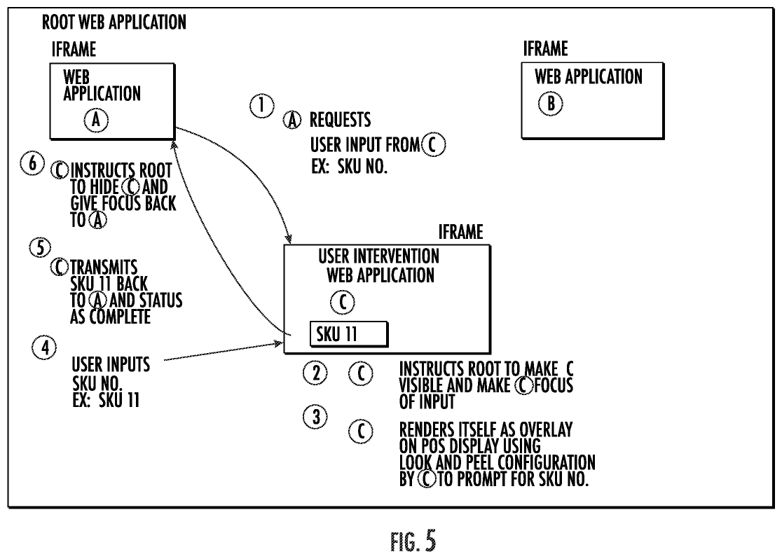

FIGS. 3 and 4 are schematic representations of alternative user input boxes 300 and 400 rendered to have a first look and feel and a second look and feel, respectively, by a user intervention web application 115 in accordance with some embodiments of the present disclosure. As shown in FIG. 3, the user input box 300 includes a plurality of first elements that are rendered by the user intervention web application 115 according to a first graphical arrangement of the elements. As shown in FIG. 4, the user input box 400 includes a plurality of second elements that are rendered by the user intervention web application 115 according to a second graphical arrangement of the elements. As shown by FIGS. 3 and 4, the user intervention web application 115 is configured to render the input box according to the instructions that are includes in the user intervention web application 115. In FIG. 3, a first set of instructions in the user intervention web application 115 renders the user input box 300 to appear as shown, regardless of which of the web application requests the user input.

In contrast, in FIG. 4 a second set of instructions in the user intervention web application 115 renders the user input box 400 to appear as shown (differently than input box 300), regardless of which of the web application requests the user input. In still further embodiments according to the present disclosure, the API call to the user intervention web application 115 for rendering of the input box can include an indication of which one of a plurality of the graphical arrangement of the elements is to be used when rendering the user input box.

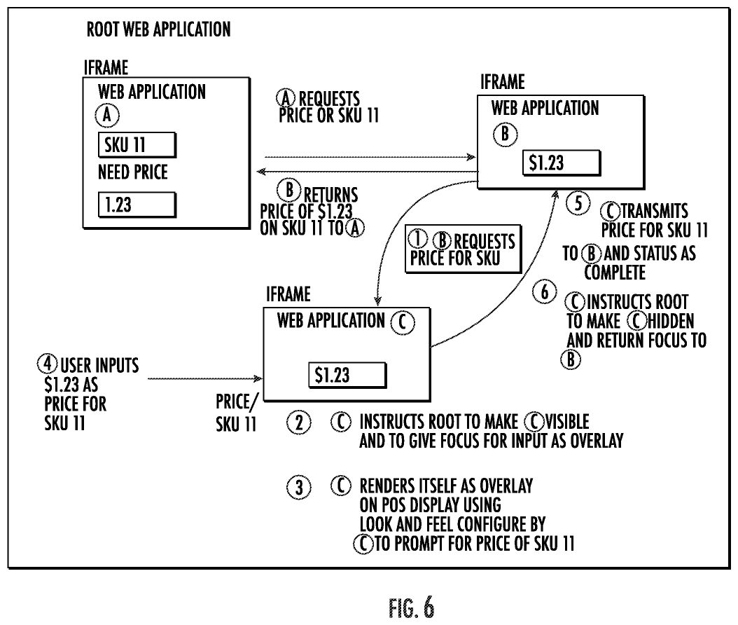

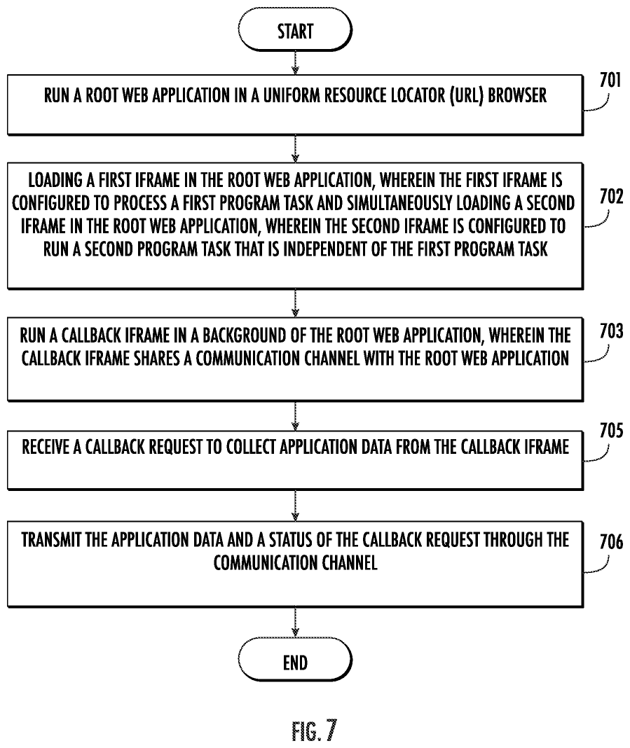

FIGS. 5 and 6 are schematic representations of operations of web applications 110 and 135 within the system 100 providing a more consistent look and feel for user input boxes via a user intervention web application 115 in accordance with some embodiments of the present disclosure. In particular, FIG. 5 illustrates operation when during a sales transaction, the POS web application 110 requires an SKU or UPC of an item to be purchased. In response, the POS web application 110 transmits a request (1) for user input to the user intervention web application 115. It will be understood that the root web application 105 provides the communication channel between the POS web application 110 and the user intervention web application 115

When the user intervention web application 115 receives the request (1), the user intervention web application 115 requests that the root 105 make the user intervention web application 115 visible as overlay on the display of the terminal system 100 and make the user intervention web application 115 the focus for input among the web applications. The user intervention web application 115 then renders the user input box (3) using the graphical arrangement of elements called for in the user input box.

When the user provides the requested input via the user input box (4), the user intervention web application 115 transmits the input data as the SKU to the POS web application 110 user intervention web application 115 (5). The user intervention web application 115 also transmits the status of the request (e.g., complete or cancelled) with the input data to the POS web application 110. The user intervention web application 115 then requests (6) that the root 105 make the user intervention web application 115 hidden on the display of the terminal system 100 and requests that the focus of input be returned to the POS web application 110.

Referring to FIG. 6, further operation of the terminal 100 are shown where the POS web application 110 requests a price for the SKU received in FIG. 5 from the host web application 135. As shown in FIG. 6, the POS web application 110 transmits a request for the price for the SKU to the host web application 135. The host web application 135 transmits a request (1) for user input to the user intervention web application 115.

When the user intervention web application 115 receives the request (1) from the host web application 135, the user intervention web application 115 requests that the root 105 make the user intervention web application 115 visible as overlay on the display of the terminal system 100 and to make the user intervention web application 115 the focus for input among the web applications. The user intervention web application 115 then renders the user input box (3) using the graphical arrangement of elements called for in the user input box.

When the user provides the requested price as the input via the user input box (4), the user intervention web application 115 transmits the input data as the price to the host web application 135 (5). The user intervention web application 115 also transmits the status of the request (e.g., complete or cancelled) with the input data to the host web application 135. The user intervention web application 115 then requests (6) that the root 105 make the user intervention web application 115 hidden again on the display of the terminal system 100 and requests that the focus of input be returned to the host web application 135. The host web application 135 then returns the price ($1.23) to the POS web application for completion of the sales transaction.

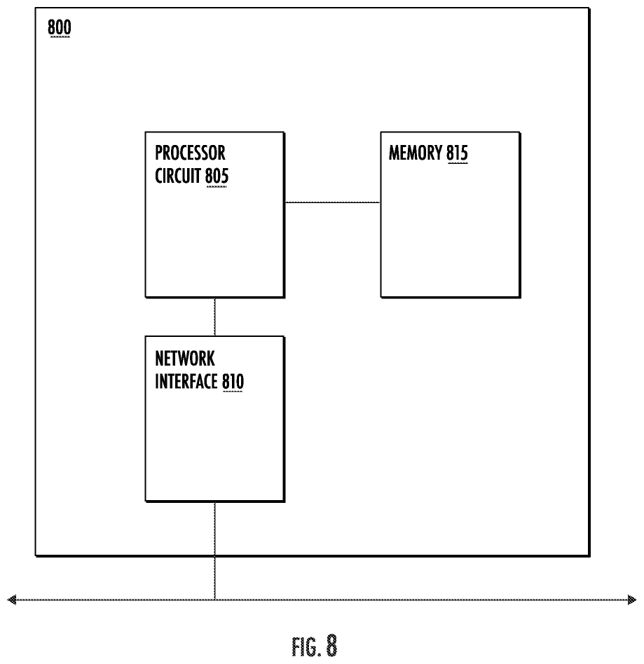

FIG. 7 is a flowchart illustrating methods of providing consistent look and feel for user input using a user intervention web application in accordance with some embodiments of the present disclosure. According to FIG. 7, a root web application may be running in a Uniform Resource Locator (URL) browser (step 701). The root web application may load a first IFrame (A) in the root web application. The first IFrame (A) is configured to process a first program task. At the same time, the root web application may load a second IFrame (C) in the root web application. The second IFrame (B) may be configured to run a second program task independent of the first program task (step 702).

It should be appreciated that the IFrames are not limited to two IFrames, A and B. There may be a plurality of stand-alone IFrames running in the root application. Furthermore, all IFrames may be in communication with IFrame C through a designated communication channel.

At step 703 the root application may run a callback IFrame (C) simultaneously with the first IFrame (A) and IFrame (B). The callback IFrame may run in the background and not be visible to the user. The callback IFrame (C) may be configured to appear on the user interface as a dialog box when input is requested from the root application, IFrame (A) or IFrame (B). A communication channel is shared among the root and all IFrames, including the callback IFrame.

The callback (C) iFrame may support an Application Programming Interface (API) as described herein. In some embodiments according to the present disclosure, the API call may specify a selected look and feel to be used when rendering the user input box to request the specified input from the user. Accordingly, the callback In some embodiments, the look and feel may be shared among the root and IFrames to create a cohesive look among the stand-alone user interfaces generated by each IFrame.

At step 705 a callback request can be issued to collect application data from the callback IFrame (C) through the communication channel. The callback request may be issued by the root application or IFrames (A) or (B). As mentioned above, the callback request is a request for user data, including look and feel data, user input data, or application data associated with the root or an IFrame. Once transmitted by the requester and received by the callback IFrame at step 706, the callback frame processes the request. The callback IFrame then returns the requested user data through the communication channel to the platform's original requester.

FIG. 8 is a block diagram of a point-of-sale terminal system 800 operating the user intervention web application 115 on a processor circuit 805 coupled to a memory 815 and a network interface 810 in some embodiments according to the present disclosure. The system 800 is configured to execute instructions stored in the memory 815 to provide the operations described herein and as illustrated in FIGS. 1-7 in some embodiments according to the present disclosure. According to FIG. 8, the processor circuit 805 coordinates overall operations of the system 800. As further shown in FIG. 8 the processor circuit 805 is coupled to the memory 815 which can store data and the instructions associated with the web applications 110, 115, 130, and the system services application 125.

As further shown in FIG. 8, the processor circuit 805 is coupled to the network interface 810 which is coupled (directly or indirectly) to a bus 820, such as the durable message bus 205 that can be used to communicate with other systems, servers, controllers and endpoints across the system 100. In some embodiments according to the present disclosure, the system can be a POS terminal marketed by Toshiba Global Commerce Solutions, Inc. of Durham, N.C.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Similarly, as used herein, the word “or” is intended to cover inclusive and exclusive OR conditions. In other words. A or B or C includes any or all of the following alternative combinations as appropriate for a particular usage: A alone; B alone: C alone; A and B only: A and C only; B and C only; and A and B and C.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Non-volatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed:

1. A method of operating a Point-of-Sale terminal, the method comprising:
operating a root web application in a Uniform Resource Locator browser on the Point-of-Sale terminal, wherein the root web application is configured to provide respective communication channels between a plurality of web applications each running in a respective iFrame within the root web application;
receiving, at a user intervention web application configured to render a user input box with a first graphical arrangement of elements in an iFrame on a display of the POS terminal, requests for user input from the plurality of web applications; and
rendering, using the user intervention web application, a user input box for each of the requests for the user input from the plurality of web applications, wherein each user input box rendered with the first graphical arrangement of elements.

2. The method of claim 1 wherein receiving, at the user intervention web application, requests for user input from the plurality of web applications comprises:
receiving, at the user intervention web application, a first request for first user input from a first web application in a first iFrame; and
receiving, at the user intervention web application, a second request for second user input from a second web application in a second iFrame.

3. The method of claim 2 wherein rendering, using the user intervention web application, the user input box for each of the requests comprises:
rendering, using the user intervention web application, a first user input box having the first graphical arrangement of elements in response to receiving the first request for first user input from the first web application; and
rendering, using the user intervention web application, a second user input box having the first graphical arrangement of elements in response to receiving the second request for first user input from the second web application.

4. The method of claim 3 further comprising:
determining that the first request for first user input has a first priority; and
determining that the second request for second user input has a second priority, wherein rendering the first user input box and rendering the second user input box are performed in descending order according to the first priority and the second priority.

5. The method of claim 1 further comprising:
transmitting a first request for a first user input from a first web application in a first iFrame to the user intervention web application, wherein the first web application is configured to process a first program task included in Point-of-Sale terminal operations; and
transmitting a second first request for a second user input from a second web application in a second Iframe to the user intervention web application, wherein the second web application is configured to process a second program task included in the Point-of-Sale terminal operations.

6. The method of claim 5 wherein transmitting the first request for the first user input and transmitting the second first request for the second user input comprises transmitting the first and second requests using a POS terminal API including a title for the user input box, a prompt for the user input box, a description for the user input box, input fields for inclusion in the user input box, and/or buttons shown in the user input box.

7. The method of claim 1 wherein the user intervention web application is hidden from the display prior to receiving the requests for user input from the plurality of web applications at the user intervention web application, the method further comprising:
receiving a first request, at the user intervention web application, from a first web application in a first iFrame for first user input;
transmitting a request from the user intervention web application to the root web application to make the user intervention web application visible on the display responsive to receiving the first request for the first user input at the user intervention web application;
using the root web application, changing a state of the user intervention web application from hidden to visible responsive to the request from the user intervention web application to the root web application to make the user intervention web application visible;
rendering the user input box having the first graphical arrangement of elements on the display;
receiving, at the user intervention web application, the first user input via the user input box having the first graphical arrangement of elements;
transmitting the first user input from the user intervention web application back to the first web application; and
transmitting a request from the user intervention web application to the root web application to make the user intervention web application hidden on the display responsive to receiving the first user input at the user intervention web application.

8. The method of claim 7 wherein transmitting the first user input from the user intervention web application back to the first web application further comprises:
transmitting a completed status for the first request from the user intervention web application back to the first web application.

9. The method of claim 7 further comprising:
receiving a second request, at the user intervention web application, from a second web application in a second iFrame for second user input;
transmitting a request from the user intervention web application to the root web application to make the user intervention web application visible on the display responsive to receiving the second request for the second user input at the user intervention web application;
using the root web application, changing the user intervention web application state from hidden to visible responsive to the request from the user intervention web application to the root web application to make the user intervention web application visible;
rendering the user input box having the first graphical arrangement of elements on the display;
receiving, at the user intervention web application, the second user input via the user input box having the first graphical arrangement of elements;
transmitting the second user input from the user intervention web application back to the second web application; and
transmitting a request from the user intervention web application to the root web application to make the user intervention web application hidden on the display responsive to receiving the second user input at the user intervention web application.

10. The method of claim 9 wherein transmitting the second user input from the user intervention web application back to the second web application further comprises transmitting a completed status for the second request from the user intervention web application back to the second web application.

11. A method for cross IFrame communication comprising:
running a root web application in a Uniform Resource Locator URL browser;
loading a first IFrame in the root web application, wherein the first IFrame is configured to process a first program task and simultaneously loading a second IFrame in the root web application, wherein the second IFrame is configured to run a second program task that is independent of the first program task;
running a callback IFrame in a background of the root web application, wherein the callback IFrame shares a communication channel with the root web application;
receiving a callback request to collect application data from the callback IFrame;
transmitting the application data and a status of the callback request through the communication channel.

12. The method of claim 11, wherein receiving the callback request comprises receiving the callback request from the root web application, first IFrame or second IFrame.

13. The method of claim 11, wherein application data may include user input data, application data or meta elements used for describing presentation of a web application written in a markup language.

14. The method of claim 11, wherein application data and a status of the callback request through the communication channel to the root web application, first IFrame or second IFrame.

15. A Point-of-Sale terminal comprising:
a memory circuit configured to store processor instructions to perform operations of the Point-of-Sale terminal;
a processor circuit, coupled to the memory circuit to access and execute the instructions to operate a root web application in a Uniform Resource Locator browser on the Point-of-Sale terminal, wherein the root web application is configured to provide respective communication channels between a plurality of web applications each running in a respective iFrame within the root web application;
the processor circuit further configured to access and execute the instructions to receive, at a user intervention web application configured to render a user input box with a first graphical arrangement of elements on a display of the POS terminal, requests for user input from the plurality of web applications; and
the processor circuit further configured to access and execute the instructions to render, using the user intervention web application, a user input box for each of the requests for the user input from the plurality of web applications, wherein each user input box rendered with the first graphical arrangement of elements.

16. The Point-of-Sale terminal of claim 15 wherein the instructions to receive, at the user intervention web application, requests for user input from the plurality of web applications comprises:
instructions to receive, at the user intervention web application, a first request for first user input from a first web application in a first iFrame; and
instructions to receive, at the user intervention web application, a second request for second user input from a second web application in a second iFrame.

17. The Point-of-Sale terminal of claim 16 wherein the instructions to render, using the user intervention web application, the user input box for each of the requests comprises:
the instructions to render, using the user intervention web application, a first user input box having the first graphical arrangement of elements in response to receiving the first request for first user input from the first web application; and
the instructions to render, using the user intervention web application, a second user input box having the first graphical arrangement of elements in response to receiving the second request for first user input from the second web application.

18. The Point-of-Sale terminal of claim 17 further comprising:
instructions to determine that the first request for first user input has a first priority; and
instructions to determine that the second request for second user input has a second priority, wherein rendering the first user input box and rendering the second user input box are performed in descending order according to the first priority and the second priority.

19. The Point-of-Sale terminal of claim 15 further comprising:
instructions to transmit a first request for a first user input from a first web application in a first iFrame to the user intervention web application, wherein the first web application is configured to process a first program task included in Point-of-Sale terminal operations; and
instructions to transmit a second first request for a second user input from a second web application in a second Iframe to the user intervention web application, wherein the second web application is configured to process a second program task included in the Point-of-Sale terminal operations.

20. The Point-of-Sale terminal of claim 19 wherein the instruction to transmit the first request for the first user input and to transmit the second first request for the second user input comprises instructions to transmit the first and second requests using a POS terminal API including a title for the user input box, a prompt for the user input box, a description for the user input box, input fields for inclusion in the user input box, and/or buttons shown in the user input box.
